(19) United States
(12) Patent Application Publication
(10) Pub. No.: US 2020/0401959 A1
(43) Pub. Date: Dec. 24, 2020

(54) EMERGENCY TRAFFIC MANAGEMENT SYSTEM USING MOBILE DEVICE

(71) Applicant: Do-Hun LEE, Gwangyang-si, Jeollanam-do (KR)

(72) Inventors: Do-Hun LEE, Gwangyang-si (KR); Jeong-Seo CHEON, Gwangyang-si (KR); Joo-Sang LEE, Gwangyang-si (KR); Ji-Min LEE, Gwangyang-si (KR)

(73) Assignee: Do-Hun LEE, Gwangyang-si, Jeollanam-do (KR)

(21) Appl. No.: 16/975,049

(22) PCT Filed: Feb. 21, 2019
(86) PCT No.: PCT/KR2019/002116

§ 371 Date: Aug. 21, 2020

(30) Foreign Application Priority Data
Feb. 21, 2018 (KR) 10-2018-0020519

(51) Int. Cl. G06Q 10/04; G06Q 50/26; G08G 1/0968; G08G 1/00; H04M 1/725

(52) U.S. Cl. CPC G06Q 10/047; G06Q 50/26; H04M 1/725; G08G 1/205; G08G 1/096811

(57) ABSTRACT

The present invention relates to an emergency traffic management system using a mobile device, wherein the system provides travelling path information to a rescue vehicle for saving life and responding to a disaster in the event of the disaster and provides disaster information to the mobile devices of the drivers in vehicles, which are travelling or are parked on the mobilization path of the rescue vehicle, so as to enable quick rescue and traffic control. The system comprises: a rescue management server (100) connected over mobile radio communication network; and a mobile device (300) carried by a driver of a normal vehicle

### TECHNICAL FIELD

The present invention relates to an emergency traffic control system using a mobile device, which provides travelling path information to a rescue vehicle for saving life and responding to a disaster in an event of the disaster and also provides disaster information to the mobile devices of the drivers in vehicles, which are travelling or parked on the mobilization path of the rescue vehicle, so as to enable quick rescue and traffic control.

### BACKGROUND ART

A background technology for the present invention includes a vehicle control system for an emergency vehicle of Korean Registered Patent Publication No 10-1746740 B1 shown in FIG. 1, and a vehicle control method using the same. The above technology has a feature of providing a vehicle control system including: a management server configured to acquire a travelling path of an emergency vehicle and transmit vehicle control information according to the travelling path of the emergency vehicle; a plurality of vehicle control devices installed at roads, and configured to receive the vehicle control information and generate a vehicle control signal based on the vehicle control information according to the travelling path of the emergency vehicle, thereby transmitting the vehicle control signal within a predetermined area around an installation location; and a normal vehicle terminal device configured to receive and output the vehicle control signal from the vehicle control device. However, this technology has a limitation in that the technology requires the vehicle control device that generates and transmits the vehicle control signal within a predetermined area around an installation location, and the normal vehicle terminal device that receives and outputs the vehicle control signal.

Another background technology for the present invention includes a technology for an emergency vehicle priority traffic service method using a wireless communication network of Korean Registered Patent Publication No. 10-0877478 B1 shown in FIG. 2. The above technology has a feature of providing an emergency vehicle priority traffic service method using a wireless communication network including: a first step of registering a service by an emergency vehicle management server to support a priority traffic service to roadside base stations; a second step of storing an emergency traffic message based on emergency situation (destination) information received by a vehicle-mounted device; a third step of receiving the emergency traffic message by a roadside base station from the vehicle-mounted device accessing a communication area to identify the vehicle-mounted device as a service target and transmit the emergency traffic message to the emergency vehicle management server; a fourth step of selecting roadside base stations on an expected destination path r an emergency vehicle by the emergency vehicle management server and registering emergency vehicle priority traffic information suitable for a road situation to the selected roadside base stations; a fifth step of periodically broadcasting the registered emergency vehicle priority traffic information by each of the selected roadside base stations; and a sixth step of outputting the corresponding information by the vehicle-mounted device after receiving the broadcasted emergency vehicle priority traffic information. However, the above technology has a problem in that the technology cannot be used in an area without a roadside base station, and a vehicle without the vehicle-mounted device cannot receive emergency vehicle priority traffic information.

Still another background technology for the present invention includes a method and system technology for dealing with an emergency situation using a GPS terminal of Unexamined Patent Publication No. 10-2006-0122626 A shown in FIG. 3. The above technology relates to a method and a system for dealing with an emergency situation using a GPS terminal so that an emergency vehicle promptly drives n an urgent situation, wherein an emergency vehicle GPS terminal transmits an emergency message to an emergency message management center, the emergency message management center, which has received the message, transmits a warning message for informing that the emergency vehicle is in operation to a normal vehicle GPS terminal, and the normal vehicle GPS terminal receiving the warning message notifies the user that the warning message has been received. However, since this technology is configured to transmit a warning message to ail the normal vehicle GPS terminals in an area where the emergency vehicle is in operation, and thus transmits the warning message even to nearby vehicles where the emergency vehicle is not in operation, thereby causing an unnecessary traffic chaos.

In addition, the existing background technologies are configured to mount a terminal device on a normal vehicle, and thus have a limitation in that, even if the vehicle parked on a travelling path of an emergency vehicle is provided with priority traffic information or warning messages, a driver of the parked vehicle cannot respond thereto.

### DISCLOSURE

### Technical Problem

An object of the present invention is to provide an emergency traffic control system using a mobile device, wherein the system provides travelling path information to a rescue vehicle for saving life and responding to a disaster in an event of the disaster and also provides disaster information to vehicles, which are travelling or parked on the travelling path of the rescue vehicle, so as to enable quick rescue and traffic control.

### Technical Solution

The present invention provides an emergency traffic control system using a mobile device, which includes a rescue management server connected over a mobile communication network, and a mobile device carried by a driver of a normal vehicle, wherein, when disaster data are inputted into the rescue management server, the rescue management server provides the rescue vehicle with mobilization information and path information and transmits disaster information and a rescue vehicle mobilization path to the mobile device, and then the mobile device determines whether a road name or GPS coordinates, on which a current normal vehicle is travelling or parked, belongs to the rescue vehicle mobilization path or not, and provides the received disaster information and the rescue vehicle mobilization path to a mobile device of a driver, if the vehicle is located at the rescue vehicle mobilization path, so as to enable prompt rescue by giving way or moving the vehicle parked.

### Advantageous Effects

According to the present invention, there is provided an emergency traffic control system using a mobile device, which provides travelling path information to a rescue vehicle in an event of disaster and also provides disaster information to vehicles, which are travelling or parked on the travelling path of the rescue vehicle, so as to enable quick rescue and traffic control.

### DESCRIPTION DRAWINGS

FIG. 1 is view showing configuration of a vehicle control system for an emergency vehicle and a vehicle control method using the same as a background technology for the present invention.

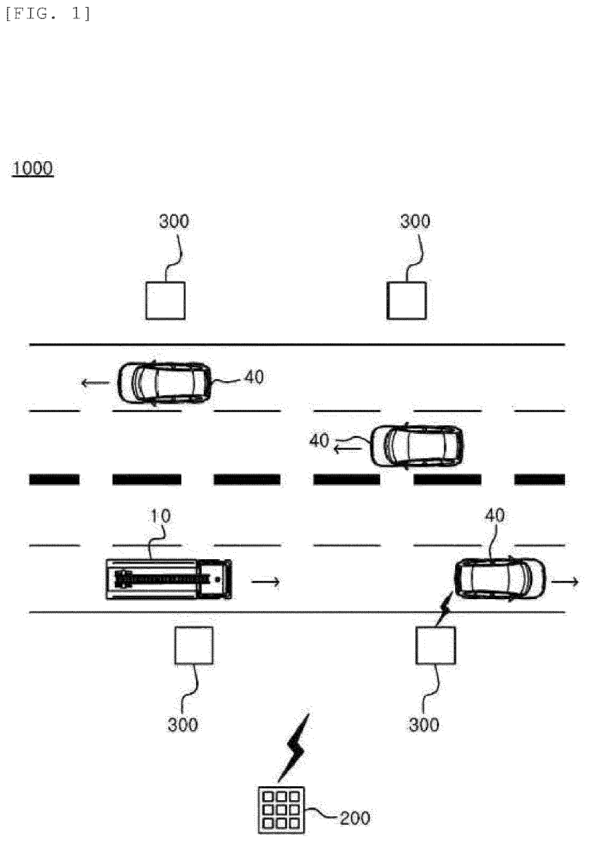

FIG. 2 is view showing configuration of an emergency vehicle priority traffic service method using a wireless communication network as another background technology for the present invention.

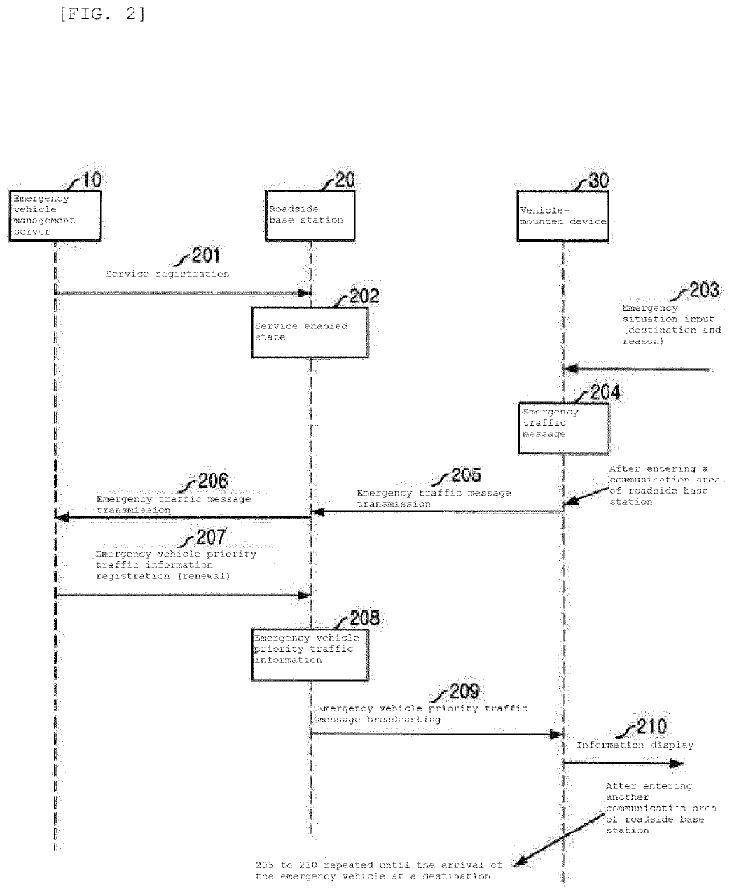

FIG. 3 is a view showing configuration of a method and system technology for dealing with emergency situations using GPS terminal as another background technology for the present invention.

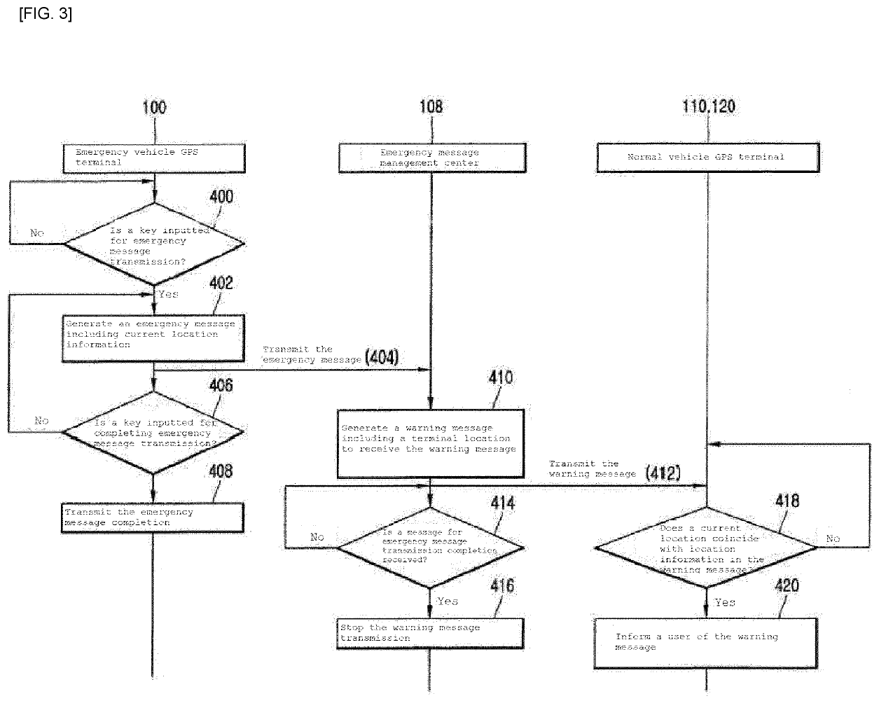

FIG. 4 is a view showing a technical background of the present invention.

FIG. 5 is a view showing main components of the present invention and an operational relationship thereof.

FIG. 6 is a view showing an operational relationship on an electronic map of the present invention.

FIG. 7 is a view showing a detailed configuration of a rescue management server 100 of the present invention.

FIG. 8 is a view showing a detailed configuration of a mobile device 300 of the present invention.

### BEST MODE

The following content merely illustrates the principles of the present invention. Accordingly, those skilled in the art to which the present technology belongs can implement the principles of the present invention and invent various devices included in the concept and scope of the present invention, though not clearly described or illustrated herein. In addition, it is to be understood that all conditional terms and embodiments listed in this specification are, in principle, expressly intended only for the purpose of making the concept of the present invention understood, and are not limited to the embodiments and states specifically listed such. Further, it is to be understood that all detailed descriptions listing specific embodiments as well as principles, aspects and embodiments of the present invention are intended to include structural and functional equivalents of these matters.

The above-described objects, features and advantages will become more apparent through the following detailed description in connection with the accompanying drawings. Further, in the description of the present invention, a detailed description of related known technology will be omitted when it may make the subject matter of the present invention unnecessarily unclear. Hereinafter, preferred embodiments of the present invention will be described in detail with reference to the accompanying drawings.

The present invention may provide an emergency traffic control system using a mobile device, wherein the system provides travelling path information to a rescue vehicle for saving life and responding to a disaster in an event of the disaster and also provides disaster information to vehicles, which are travelling or parked on the travelling path of the rescue vehicle, so as to enable quick rescue and traffic control. According to the present invention, the emergency traffic control system may provide disaster information to the mobile devices of drivers in vehicles, which are travelling or parked on the travelling path of the rescue vehicle. In addition, there may be provided the emergency traffic control system using mobile device, which selectively provides disaster information only to the vehicles on the rescue vehicle travelling path by excluding vehicles located at roads adjacent to a place of disaster other than vehicles on the rescue vehicle travelling path, and also provides disaster information to the mobile devices of the drivers in vehicles, which are parked on the travelling path, thereby enabling more prompt and efficient rescue.

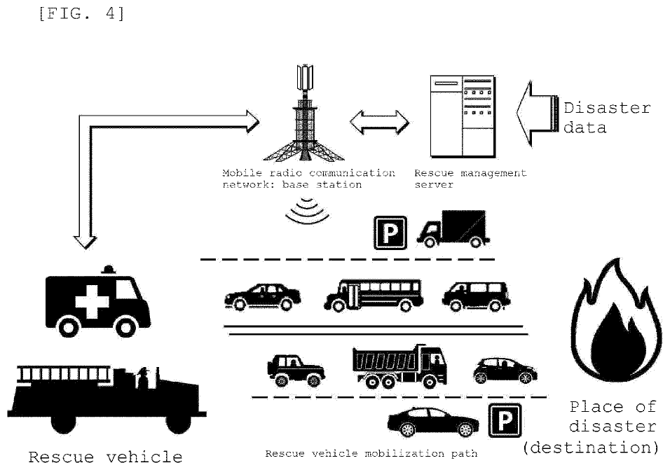

FIG. 4 shows a technical background of the present invention.

According to the present invention, the emergency traffic control system using a mobile device may be basically configured with disaster management server and a mobile device connected to the disaster management server over mobile communication network (base station). The mobile device may be provided in rescue vehicle and a driver's side of normal vehicle and may serve as a mobile communication means connected over a communication network through a conventional mobile communication base station.

If a disaster is reported and inputted as disaster data into the rescue management server, the rescue management server may provide the rescue vehicle with mobilization information including a place of disaster as a destination through the mobile communication network. In this case, the mobilization information provided may include navigation information that provides path information for the place of disaster. In addition, normal vehicles which are travelling on the rescue vehicle mobilization path may need to receive disaster information and provide the traffic path to the rescue vehicle. Further, the drivers of vehicles which are parked on the rescue vehicle mobilization path may need to be informed of disaster information and that vehicles are parked on the rescue vehicle mobilization path, thereby allowing the rescue vehicle to secure a passage.

For this purpose, the present invention may provide the disaster information and the rescue vehicle mobilization path information to the mobile devices of drivers over a mobile communication network (base station). However, in the case of providing only the disaster information and the rescue vehicle mobilization path over a mobile communication network (base station), there may be a problem in that it is necessary to select a mobile communication base station corresponding to the place of disaster. With a conventional technology, it may be also impossible to provide the disaster information and the rescue vehicle mobilization only to the mobile devices of drivers in vehicles which are travelling or parked on the rescue vehicle mobilization path within a service area (macro cell) of a mobile communication base station.

To solve this problem, it may be possible to consider a technology for determining the disaster information by driver's mobile device located within a certain area from the place of disaster with reference to GPS coordinates from the driver's mobile device. In this case, however, it may be impossible to distinguish mobile devices in vehicles on the rescue vehicle mobilization path from mobile devices in vehicles located at nearby roads other than the rescue vehicle mobilization path, thereby causing a traffic congestion to provide a passage for the rescue vehicle.

To solve the above problems, the present invention may provide an emergency traffic control system using a mobile device, wherein the system provides disaster information and rescue vehicle mobilization path information to mobile devices of drivers in vehicles through a mobile communication network (base station) and the mobile device determines whether the vehicles of drivers are travelling or parked on the rescue vehicle mobilization path or not, thereby taking an action.

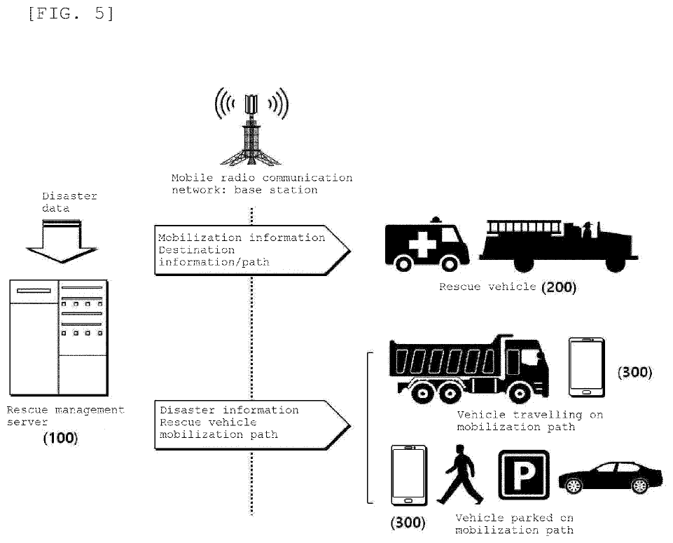

FIG. 5 shows main components of the present invention and an operational relationship thereof.

According to the present invention, there may be provided the emergency traffic control system using a mobile device, wherein if a disaster is reported and inputted as disaster data into the rescue management server 100, the rescue management server 100 provides the rescue vehicle with mobilization information including a place of disaster and path information including the place disaster as a destination through the mobile communication network. The path information provided in this case may include names of roads through which the rescue vehicle goes to the place of disaster, the junctions of roads to be passed, and the GPS coordinates for the names of associated roads. Furthermore, the rescue management server 100 may transmit disaster information including the place of disaster and a type of disaster as well as the rescue vehicle navigation information as a rescue vehicle mobilization path to the place of disaster, to a mobile device 300 carried by a driver of a normal vehicle through the mobile communication network.

In the emergency traffic control system using a mobile device according to the present invention, a navigation is activated in the mobile device 300 carried by a driver in a normal vehicle to store current GPS coordinates of the normal vehicle and a road name corresponding thereto at a set time interval. Thus, as described above, when the mobile device 300 receives the point of disaster, disaster information, and the rescue vehicle mobilization path information including the names of roads through which the rescue vehicle goes to the place of disaster, the junctions of roads to be passed, and the GPS coordinates for names of associated roads from the rescue management server 100, the mobile device 300 may determine whether the road name or the GPS coordinates, on which the current normal vehicle is travelling or parked, belongs to the rescue vehicle mobilization path or not, and may provide the received disaster information and the rescue vehicle mobilization path to the mobile device 300 of the driver, if the vehicle is located at the rescue vehicle mobilization path, so as to enable quick rescue by giving way or moving the vehicle parked. In this case, the driver's mobile device 300 may be configured to provide an alarm along with the disaster information and the rescue vehicle mobilization path.

Thus, the present invention may not limit the mobile communication network base station that provides the disaster information and the rescue vehicle mobilization path. That's because the emergency traffic control system using a mobile device according to the present invention may be configured to provide the disaster information and the rescue vehicle mobilization path only to the vehicle located on the rescue vehicle mobilization path, if the mobile device 300 carried by a driver in any normal vehicle receives the point of disaster, the disaster information and the rescue vehicle mobilization path information including the names of roads through which the rescue vehicle goes to the place of disaster, the junctions of roads to be passed, and the GPS coordinates for the names of associated roads from the rescue management server 100.

The present invention may be configured to determine a location of the current vehicle through the mobile device 300 carried by a driver in the normal vehicle, so that when the driver is driving, the location of the vehicle may coincide with the location of the mobile device 300, but when the driver parks while carrying the mobile device 300, it may be necessary to refer to the location of the vehicle parked rather than the location of the mobile device 300. For this purpose, the mobile device 300 of the present invention may read the GPS coordinates at a set time interval, convert a distance change based on the read GPS coordinates into a speed according to a set time interval, and maintain the road name and the GPS coordinates as previously stored values at a predetermined speed or lower, thereby determining that the vehicle is parked. As an example, in case that a driver carrying the mobile device 300 moves by walk, the device may move at a maximum average speed of 8 Km/h. Thus, on the basis of 10 Km/h, if the speed of the device is considered as 10 Km/h or lower, it may be determined that the vehicle is parked while maintaining the road name and the GPS coordinates at previously stored values.

Thus, the emergency traffic control system using a mobile device according to the present invention may provide the rescue vehicle with mobilization information and path information for the place of disaster through the rescue management server 100 connected over a mobile communication network, may provide disaster information and rescue vehicle mobilization path to the mobile device 300 carried by a driver in a normal vehicle, may allow each mobile device 300 to determine whether a road name or GPS coordinates, on which the driver's vehicle is travelling or parked, belongs to the rescue vehicle mobilization path or not, and may provide the received disaster information and the rescue vehicle mobilization path to the mobile device 300 of a driver, if the vehicle is located at the rescue vehicle mobilization path.

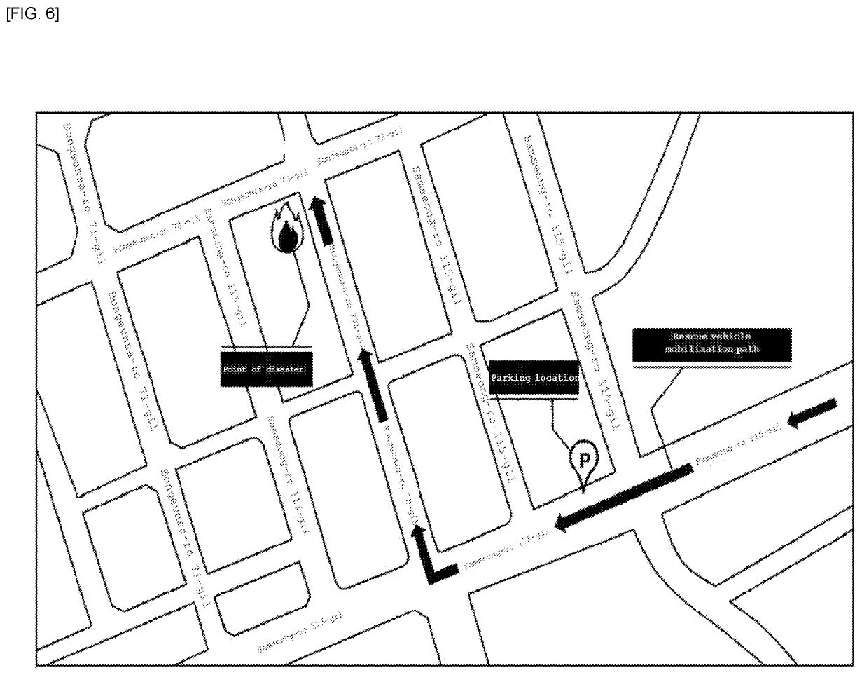

FIG. 6 shows an operational relationship on an electronic map of the emergency traffic control system using a mobile device according to the present invention. As described above, when disaster data are inputted into the rescue management server 100, the rescue management server 100 may provide the rescue vehicle with mobilization information including a place of disaster and path information including the place of disaster as a destination through the mobile communication network. In this case, the path information provided may include a road name such as “Samseong-ro 115-gil” “Bongeunsa-ro -gil” as names of roads through which the rescue vehicle goes to the place of disaster, the names of associated roads, and the GPS coordinates for each road section. Then, the rescue management server 100 may transmit disaster information including a point of disaster and a type Of disaster, and the rescue vehicle mobilization path information for the place of disaster to the mobile device 100 carried by a driver in the normal vehicle. The mobile device 300 may determine whether the road name or the GPS coordinates, on which the current normal vehicle travelling or parked, belongs to the rescue vehicle mobilization path or not with reference to the received rescue vehicle mobilization path information, and may provide the received disaster information and the rescue vehicle mobilization path along with an alarm to the mobile device 300 of a driver, if the vehicle is located at the rescue vehicle mobilization path, so as to enable quick rescue by giving way or moving the vehicle parked.

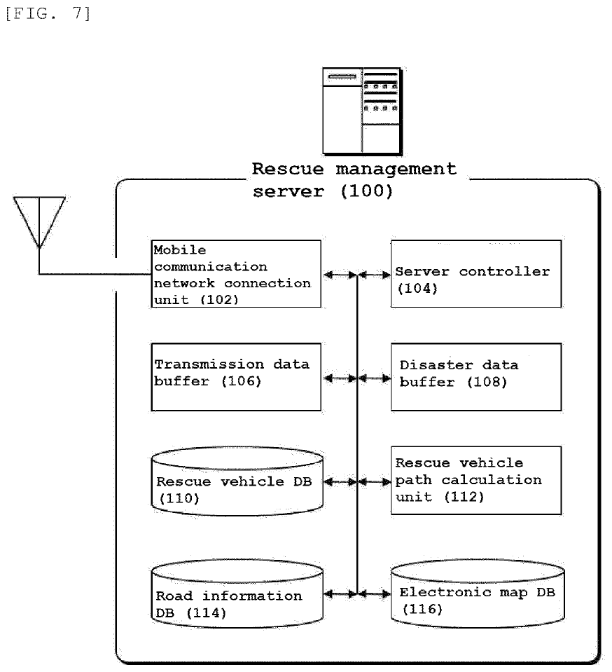

FIG. 7 shows a detailed configuration of a rescue management server 100 in the emergency traffic control system using a mobile device according to the present invention. According to the present invention, the rescue management server 100 may include: a server controller 104 for performing a control of the rescue management server 100; a mobile communication network connection unit 102 for receiving disaster data, providing the rescue vehicle with the point of disaster, the disaster information, and the rescue vehicle mobilization path information including the names of roads through which the rescue vehicle goes to the place of disaster, the junctions of roads to be passed, and the GPS coordinates for names of associated roads, and transmitting the disaster information and the rescue vehicle mobilization path to the mobile device 300 carried by the driver of the normal vehicle; a transmission data buffer 106 as a workspace for configuring information transmitted to the rescue vehicle and the mobile device 300; a disaster data buffer 108 for storing the disaster data provided over a mobile communication network or a separate wired/wireless communication channel; a rescue vehicle DB 110 for storing information on rescue vehicles for providing the mobilization information and the rescue vehicle mobilization path information corresponding to a region mating with disaster data and a disaster type; an electronic map DB 116 including road network information; a road information DB 114 for storing the names of roads corresponding to the electronic map, the junctions of roads to be passed, and the GPS coordinates for the names of associated roads; and a rescue vehicle path calculation unit 112 for receiving the disaster data and calculating the point of disaster, the disaster information and the rescue vehicle mobilization path information including the names of roads through which the rescue vehicle goes to the place of disaster, the junctions of roads to be passed, and the GPS coordinates for the names of associated roads.

Through the above configuration according to the present invention, the server controller 104 of the rescue management server 100,

may receive the disaster data provided through a mobile communication network connection unit 102 or a separate wired/wireless communication channel and may store the data in the disaster data buffer 108; calculate the point of disaster, the disaster information, and the rescue vehicle mobilization path information including the names of roads through which the rescue vehicle goes to the place of disaster, the junctions of roads to be passed, and the GPS coordinates for the names of associated roads, with reference to the electronic map DB 116 and the road information DB 114; provide the point of disaster and the rescue vehicle mobilization path information to the rescue vehicle via the transmission data buffer 106 and the mobile communication network connection unit 102 with reference to the rescue vehicle DB 110; and transmit the disaster information and the rescue vehicle mobilization path to the driver's mobile device 300 through the mobile communication network connection unit 102.

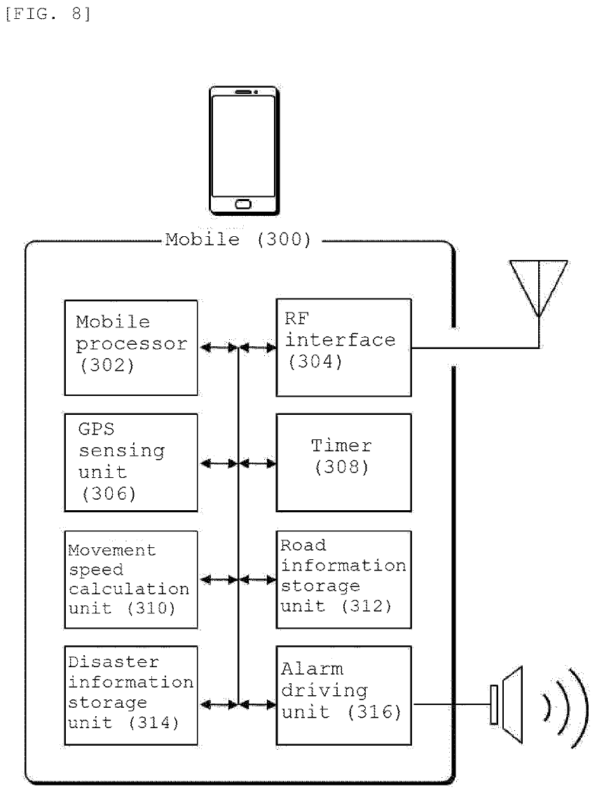

FIG. 8 shows a detailed configuration of a mobile device 300 in the emergency traffic control system using a mobile device according to the present invention. In the present invention, the mobile device 300 of each driver travelling or parked on road may include: a mobile processor 302 for performing a control of the mobile device; an RF interface 304 for connecting the mobile device 300 to the mobile communication network; a GPS sensing unit 306 for extracting the GPS coordinates of the mobile device 300; a timer 308 for setting a time interval for reading the GPS coordinates from the GPS sensing unit 306; a movement speed calculation unit 310 for calculating a distance change based on the GPS coordinates read from the GPS sensing unit 306 into a movement speed according to a set time interval; road information storage unit 312 for storing the road name corresponding to the GPS coordinates read from the GPS sensing unit 306; disaster information storage unit 314 for storing the disaster information transmitted from the rescue management server 100 and received through the RF interface 304, and the rescue vehicle mobilization path; and an alarm driving unit 316 configured to be driven when the vehicle is located at the rescue vehicle mobilization path with respect to the received disaster information and the rescue vehicle mobilization path.

Thus, according to the present invention, the mobile processor 302 of the mobile device 300 may read the GPS coordinates from the GPS sensing unit 306 at every time interval set by a timer 308; convert a distance change based on the read GPS coordinates into a speed according to a set time interval, and determine that the vehicle is parked when the speed is equal to or lower than a predetermined speed, thereby maintaining the road name and the GPS coordinates stored in the road information storage unit 312 with previously stored values, or store the road name corresponding to the read GPS coordinates and the GPS coordinates into the road information storage unit 312 when the speed is more than the predetermined speed; store the disaster information and the rescue vehicle mobilization path information received from the rescue management server 100 through the RF interface 304 into the disaster information storage unit 314; determine whether the road name or the GPS coordinates on which the vehicle is travelling or parked belongs to the rescue vehicle mobilization path with reference to the road name and the GPS coordinates stored in the road information storage unit 312, the disaster information stored in the disaster information storage unit 314, and the rescue vehicle mobilization path information; and provide the received disaster information and the rescue vehicle mobilization path along with an alarm, if the vehicle is located at the rescue vehicle mobilization path, so as to enable quick rescue by giving way to the rescue vehicle or moving the vehicle parked on the mobilization path.

As described above, the emergency traffic control system using a mobile device according to the present invention has a feature of providing travelling path information to a rescue vehicle for saving life and responding to a disaster in an event of the disaster and also providing disaster information to the mobile devices of the drivers in vehicles, which are travelling or parked on the mobilization path of the rescue vehicle, so as to enable quick rescue and traffic control. In addition, although the present invention has been described limited to an emergency traffic control system, it can be used as a traffic control means for evacuation and rescue in response to a disaster (earthquake, volcanic eruption, etc.) over a wide area.

According to the present invention, the emergency traffic control system using a mobile device has been described with limited embodiments and drawings, but the present invention is not limited thereto, and can be variously modified and changed within the scope of the technical spirit of the invention and the claims to be described below by those skilled in the art to which the present invention belongs.

### INDUSTRIAL APPLICABILITY

The present invention relates to an emergency traffic control system using a mobile device, which provides travelling path information to a rescue vehicle in an event of disaster and also provides disaster information to vehicles, which are travelling or parked on tie travelling path of the rescue vehicle, so as to enable quick rescue and traffic control, thereby contributing to industrial development.

1. An emergency traffic control system using a mobile device, which provides travelling path information to a rescue vehicle for saving life and responding to a disaster in an event of the disaster and provides disaster information to vehicles, which are travelling or parked on a travelling path of the rescue vehicle, so as to enable quick rescue and traffic control, the system comprising:
a rescue management server (100) connected over a mobile communication network; and
a mobile device (300) carried by a driver of a normal vehicle,
wherein, when disaster data are inputted into the rescue management server (100), the rescue management server (100) provides the rescue vehicle with mobilization information including a place of disaster and path information including names of roads through which the rescue vehicle goes to the place of disaster, junctions of roads to be passed, and GPS coordinates for names of associated roads, and transmits to the mobile device (300) disaster information including a point of disaster and a type of disaster, and a rescue vehicle mobilization path to the place of disaster,
and wherein a navigation is activated in the mobile device (300) to store current GPS coordinates of the normal vehicle and a road name corresponding thereto at a set time interval, so that when the mobile device (300) receives the point of disaster, disaster information, and the rescue vehicle mobilization path information including names of roads through which the rescue vehicle goes to the place of disaster, junctions of roads to be passed, and GPS coordinates for names of associated roads from the rescue management server (100), the mobile device (300) determines whether the road name or the GPS coordinates, on which the current normal vehicle travelling or parked, belongs to the rescue vehicle mobilization path or not, and provides the received disaster information and the rescue vehicle mobilization path to the mobile device (300) of the driver, if the vehicle is located at the rescue vehicle mobilization path, so as to enable quick rescue by giving way to the rescue vehicle or moving the vehicle parked on the mobilization path.

2. The emergency traffic control system using a mobile device of claim 1, wherein the rescue management server (100) includes:
a server controller (104) for performing a control of the rescue management server (100);
a mobile communication network connection unit (102) for receiving disaster data, providing the rescue vehicle with the point of disaster, the disaster information, and the rescue vehicle mobilization path information including the names of roads through which the rescue vehicle goes to the place of disaster, the junctions of roads to be passed, and the GPS coordinates for names of associated roads, and transmitting the disaster information and the rescue vehicle mobilization path to the mobile device (300) carried by the driver of the normal vehicle;
transmission data buffer (106) as a workspace for configuring information transmitted to the rescue vehicle and the mobile device (300);
disaster data buffer (108) for storing the disaster data provided over mobile communication network or separate wired/wireless communication channel;
a rescue vehicle DB (110) for storing information on rescue vehicles for providing the mobilization information and the rescue vehicle mobilization path information corresponding to a region mating with disaster data and a disaster type;
an electronic map DB (116) including road network information; a road information DB (114) for storing the names of roads corresponding to the electronic map, the junctions of roads to be passed, and the GPS coordinates for the names of associated roads; and
a rescue vehicle path calculation unit (112) for receiving the disaster data and calculating the point of disaster, the disaster information and the rescue vehicle mobilization path information including the names of roads through which the rescue vehicle goes to the place of disaster, the junctions of roads to be passed, and the GPS coordinates for the names of associated roads.

3. The emergency traffic control system using mobile device of claim 2, wherein the server controller (104) receives the disaster data provided through mobile communication network connection unit (102) or a separate wired/wireless communication channel and stores the data in the disaster data buffer (108);
calculates the point of disaster, the disaster information, and the rescue vehicle mobilization path information including the names of roads through which the rescue vehicle goes to the place of disaster, the junctions of roads to be passed, and the GPS coordinates for the names of associated roads, with reference to the electronic map DB (116) and the road information DB (114);
provides the point of disaster and the rescue vehicle mobilization path information to the rescue vehicle via the transmission data buffer (106) and the mobile communication network connection unit (102) with reference to the rescue vehicle DB (110); and
transmits the disaster information and the rescue vehicle mobilization path to the driver's mobile device (300) through the mobile communication network connection unit (102).

4. The emergency traffic control system using a mobile device of claim 1, wherein the mobile device (300) includes:
a mobile processor (302) for performing a control of the mobile device;
an RF interface (304) for connecting the mobile device (300) to the mobile communication network;
a GPS sensing unit (306) for extracting the GPS coordinates of the mobile device (300);
a timer (308) for setting a time interval for reading the GPS coordinates from the GPS sensing unit (306);
a movement speed calculation unit (310) for calculating a distance change based on the GPS coordinates read from the GPS sensing unit (306) into a movement speed according to a set time interval;
a road information storage unit (312) for storing the road name corresponding to the GPS coordinates read from the GPS sensing (306);
a disaster information storage unit (314) for storing the disaster information transmitted from the rescue management server (100) and received through the RF interface (304), and the rescue vehicle mobilization path; and
an alarm driving unit (316) configured to be driven when the vehicle located at the rescue vehicle mobilization path with respect to the received disaster information and the rescue vehicle mobilization path.

5. The emergency traffic control system using mobile device of claim 4, wherein the mobile processor (302) reads the GPS coordinates from the GPS sensing unit (306) at every time interval set by a timer (308);
converts a distance change based on the read GPS coordinates into a speed according to a set time interval, and determines that the vehicle is parked when the speed is equal to or lower than a predetermined speed, thereby maintaining the road name and the GPS coordinates stored in the road information storage unit (312) with previously stored values, or stores the road name corresponding the read GPS coordinates and the GPS coordinates into the road information storage unit (312) when the speed is more than the predetermined speed;
stores the disaster information and the rescue vehicle mobilization path information received from the rescue management server (100) through the RF interface (304) into the disaster information storage unit (314);
determines whether the road name or the GPS coordinates on which the vehicle is travelling or parked belongs to the rescue vehicle mobilization path with reference to the road name and the GPS coordinates stored in the road information storage unit (312), the disaster information stored in the disaster information storage unit (314), and the rescue vehicle mobilization path information; and
provides the received disaster information and the rescue vehicle mobilization path along with an alarm, if the vehicle is located at the rescue vehicle mobilization path.
